(19) United States
(12) Patent Application Publication
(10) Pub. No.: US 2007/0237588 A1
(43) Pub. Date: Oct. 11, 2007

(54) Cutting tool integral cooling groove

(76) Inventor: Jeffrey D. Russell, Rochester, MI (US)

Correspondence Address: REISING, ETHINGTON, BARNES, KISSELLE, P.C., P O BOX 4390, TROY, MI, 48099-4390, US

(21) Appl. No.: 11/728,411

(22) Filed: Mar. 26, 2007

Related U.S. Application Data
(60) Provisional application No. 60/785,695, filed on Mar. 24, 2006.

(51) Int. Cl. B23C 5/00

(52) U.S. Cl. 407/11

(57) ABSTRACT

A cutting tool is provided. The cutting tool includes a tool body having a plurality of slots therein for receiving cutting inserts. An annular ring is fixed to the tool body. The annular ring has a plurality of cooling grooves adjacent the slots for directing air to the cutting insert. The slots are provided at acute angles in two planes to provide air flow to the cutting insert.

### CROSS-REFERENCE TO RELATED APPLICATION

This application claims the benefit of U.S. Provisional Application No. 60/785,695 filed Mar. 24, 2006, the entire specification of which is expressly incorporated herein by reference.

### FIELD OF THE INVENTION

The present invention relates to cutting tools used for the formation of removing chips from a underlying material. More particularly, the present invention relates to a cooling groove for a rotary cutting tool.

### BACKGROUND OF THE INVENTION

Rotary cutting tools are used in a wide range of manufacturing applications to machine a wide variety of materials. A problem with cutting tools is the heat generated during the formation and removal of a chip of material from the surface being machined. With rotary cutting tools, applying coolant to the cutting tool surface can help reduce the effect of heat formed during chip formation. The application of coolant can also help remove the formed chip from the surface of the cutter. However, coolant cannot be used in all cutting applications because the coolant may damage or impart undesirable characteristics to the material being cut. It is often desirable to reduce or eliminate coolant in the cutting process. It would be desirable to an provide a rotary cutting tool that reduces the heat formed during cutting and increased the tools ability to remove the formed chip from the machined surface and away from the cutting tool.

### SUMMARY OF THE INVENTION

According to the present invention, there is provided a cutting tool comprising a tool body having at least one slot therein and defining an axis of rotation. A cutting insert is disposed in the slot. At least one annular ring is fixed axially to the tool body. The annular ring has at least one cooling groove. The cooling groove is positioned adjacent to the cutting insert. Upon rotation of the tool body, the cooling groove directs air through the groove and past the cutting insert.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a rotary cutting tool with integral cooling grooves;

FIG. 2 is an enlarged view of the section 2-2 of FIG. 1; and

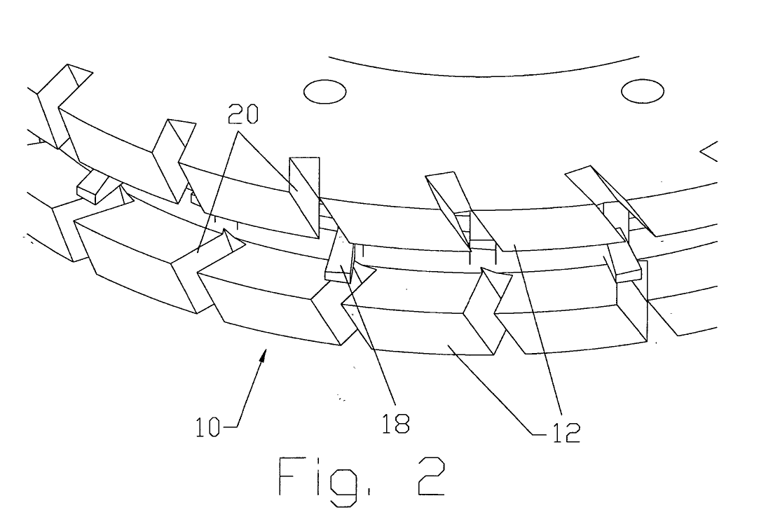

FIGS. 3 is a side view of the rotary cutting tool of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

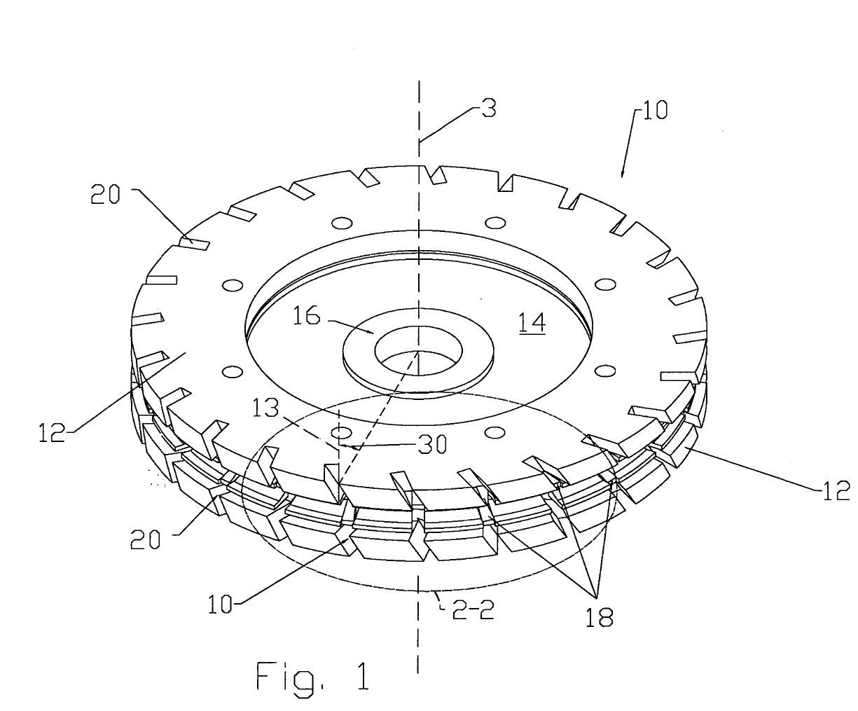

FIG. 1 shows a perspective view of a rotary cutting tool generally indicated at 10. The rotary cutting tool 10 rotates about an axis of rotation 3. The rotary cutting tool 10 can be a single piece unit or it can be formed of multiple pieces that are interconnected.

In one preferred embodiment, the rotary cutting tool 10 is formed of multiple pieces that are secured together during use of the type disclosed in U.S. Pat. No. 6,899,493 which description is incorporated herein by reference. The rotary cutting tool 10 has two outer rings 12 and a central wheel body 14 disposed between the outer rings 12. The wheel body 14 has a central wheel hub 16 that forms an aperture through which the axis of rotation 3 extends.

In one preferred embodiment, the wheel body 14 includes a plurality of slots (not shown). The slots extend radially inwardly from the outer peripheral edge of the wheel body 14. Cutting inserts 18 are disposed in the slots and extend outwardly from the peripheral surface of the wheel body 14. More specifically, the cutting inserts 18 include a body portion (not shown) adapted for disposition in the slot and a cutting portion extending outwardly from the body portion. The body portion defines a pair of side edges (not shown) that are located adjacent the outer rings 12. The cutting inserts 18 are used for removing chips of material from a medium that is being cut.

The two outer rings 12, which in the preferred embodiment are attached about the wheel body 14, include a plurality of cooling grooves 20 located adjacent the side edges of the inserts 18. The cooling grooves 20 are placed about the periphery of the outer rings 12 and extend from the outer side edge of the tool toward the slots in the tool body containing the inserts 18. As best seen in FIG. 1, the cooling grooves 20 are preferably angled in a first plane to form an acute angle 30 with respect to a radial extending line originating from the tool body axis of rotation 3. More specifically, a line 13 formed by the edge of the cooling groove 20 on the side planar surface of the outer ring 12 forms an acute angle 30 with respect to the radial extending line.

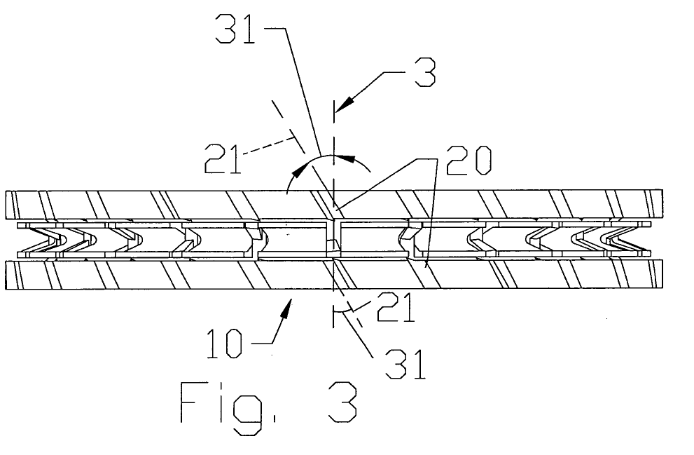

As best seen in FIG. 3, the cooling grooves 20 are also angled in a second plane to form an acute angle 31 with respect to the tool body axis of rotation 3. More specifically, a line 21 formed by the edge of the cooling groove on the radial peripheral surface of the annular ring 12 forms an acute angle with respect to the tool body axis of rotation 3. The angled configuration of the cooling grooves 20 allows air to be introduced near the inserts 18 of the wheel body 14 for cooling the cutting tool 10 as the cutting tool 10 rotates. Further, the configuration of the cooling grooves 20 allows air to be taken in on one side of the tool and vented from the opposite side.

The preferred angle 30 of the cooling grooves is between 20° and 45°. In the most preferred embodiment, the cooling grooves 20 form a 30° angle 30 to induce airflow. The cooling grooves 20 create air flow directed at the insert 18 helping to remove heat from the adjacent cutting insert 18. The cooling groove 20 also provides forced air that will aid in the removal of chips of material that have been broken away from the medium being machined. It will be appreciated that the cooling grooves 20 can be arranged at any angle to enhance the cooling capabilities as well as to optimize the amounts of air pressure flowing through the grooves 20 to the inserts 18. More specifically, in both planes, the angles 30, 31 can comprise any suitable angle of between 0° and 90°.

The cooling grooves 20 provide for the cooling of a cutting tool 10 by generating air flow through a slot in the tool body 14 during its rotation and directing this airflow onto the cutting tool insert 18. The induced airflow is directed at the cutting tool inserts 18 and results in reduced cutting temperatures. The induced airflow also enhances the cutting tools' 10 ability to remove chips from the machined surface and away from the cutting tool. While the cooling grooves 20 have been described above, these grooves may be arranged in many ways to accomplish a cooling effect depending on the geometry of the cutting tool. It is, therefore, to be understood that many variations of the invention regarding the specific geometry of the cooling grooves including, but not limited to, depth, angle, width, placement, and frequency of the cooling grooves are within the scope of the present invention.

The invention has been described in an illustrative manner, and it is to be understood that the terminology which has been used is intended to be in the nature of description rather than of limitation.

Obviously, many modifications and variations of the present invention are possible in light of the above teaching. It is, therefore, to be understood that within the scope of the appended claims, the invention may be practiced otherwise than as specifically described.

What is claimed is:

1. A cutting tool comprising:
a tool body having at least one slot therein and defining an axis of rotation;
a cutting insert disposed in said slot; and
at least one annular ring fixed axially to said tool body with at least one cooling groove, said cooling groove positioned adjacent to said cutting insert wherein upon rotation of said tool body, said cooling groove directs air through said groove and past said cutting insert.

2. A cutting tool as set forth in claim 1 wherein the said cooling groove is angled in one plane to form an angle with respect to a radial extending line from said tool body axis of rotation and which said angle is from between 0° and 90°.

3. A cutting tool as set forth in claim 1 wherein said cooling groove is angled in one plane to form an angle with respect to said tool body axis of rotation, wherein said angle is from between 0° and 90°.

4. A cutting tool as set from in claim 2 wherein said cooling groove is angled in another plane to form an angle with respect to said tool body axis of rotation, wherein said angle is from between 0° and 90°.

5. A cutting tool as set forth in claim 3 wherein said cooling groove is angled in another plane to form an angle with respect to a radial extending line from said tool body axis of rotation and wherein said angle is from between 0° and 90°.
